(19) United States
(12) Patent Application Publication
(10) Pub. No.: US 2018/0068578 A1
(43) Pub. Date: Mar. 8, 2018

(54) PRESENTING EDUCATIONAL ACTIVITIES VIA AN EXTENDED SOCIAL MEDIA FEED

(71) Applicant: Microsoft Technology Licensing, LLC, Redmond, WA (US)

(72) Inventors: Meredith Morris, Bellevue, WA (US); Nathalie Henry Riche, Issaquah, WA (US); Edward B. Cutrell, Redmond, WA (US); Andrew C. Cross, Bangalore (IN); Natasa Milic-Frayling, Cambridge (GB); Nirupama Chandrasekaran, Seattle, WA (US); Galen McQuillen, San Antonio, TX (US); Kiley Sobel, Seattle, WA (US); Geza Kovacs, San Francisco, CA (US)

(73) Assignee: Microsoft Technology Licensing, LLC, Redmond, WA (US)

(21) Appl. No.: 15/255,943

(22) Filed: Sep. 2, 2016

(51) Int. Cl. G09B 7/04; G09B 5/06; G09B 5/12; G09B 17/00; G09B 19/02

(52) U.S. Cl. CPC G09B 7/04; G09B 5/065; G09B 19/025; G09B 17/006; G09B 5/12

(57) ABSTRACT

An example system for presenting educational activities includes a computer processor and computer memory including instructions that cause the computer processor to receive a plurality of educational activities. The instructions also cause the processor to determine a learning level for a target user. The instructions further cause the processor to filter the plurality of educational activities for the target user based on the detected learning level for the target user. The instructions also further cause the processor to rank the filtered plurality of educational activities for the target user based on a social factor. The instructions also cause the processor to present the ranked educational activities to the target user in an extended social media feed.

### BACKGROUND

Social media feeds are used to present content to audiences that are generally literate. For example, a social media feed may be used by users to share various forms of media that may also include user-generated content.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

One implementation provides for a system for presenting educational activities. The system includes a computer processor and a computer-readable memory storage device storing executable instructions that can be executed by the processor to cause the processor to receive a plurality of educational activities. The executable instructions can be executed by the processor to detect a learning level for a target user. The executable instructions can be executed by the processor to filter the plurality of educational activities for the target user based on the detected learning level for the target user. The executable instructions can be executed by the processor to rank the filtered plurality of educational activities for the target user based on a social factor. The executable instructions can be executed by the processor to present the ranked educational activities to the target user in an extended social media feed.

Another implementation provides a method for presenting educational activities. The method includes receiving a plurality of educational activities. The method additionally includes detecting a learning level for a target user for each of a plurality of subjects. The method further also includes filtering the plurality of educational activities for the target user based on the determined learning levels for the target user. The method also includes ranking the filtered plurality of educational activities for the target user based on a social factor. The method further also includes presenting the ranked educational activities to the target user in an extended social media feed.

Another implementation provides for one or more computer-readable memory storage devices for storing computer readable instructions that, when executed by one or more processing devices, instruct the presenting of educational activities. The computer-readable instructions may include code to receive a plurality of educational activities. The computer-readable instructions may also include code to detect a learning level for a target user for each of a plurality of subjects. The computer-readable instructions include code to filter the plurality of educational activities for the target user based on the determined learning levels for the target user. The computer-readable instructions may also include code to rank the filtered plurality of educational activities for the target user based on a social factor. The computer-readable instructions may include code to present the ranked educational activities to the target user in an extended social media feed.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example system for presenting educational activities;

FIG. 2 is an example extended social media feed that can present educational activities;

FIG. 3 is an example sharing screen for sharing a completed activity with a friend;

FIGS. 4A-C illustrate example literacy activities that can be presented;

FIGS. 5A-C illustrate example numeracy activities that can be presented;

FIGS. 6A-C illustrate example feed variants that can be used to display educational activities;

FIGS. 7A-E illustrate example featural keyboards that can be used to reflect phonological relationships between letters;

FIGS. 8A-8D are a set of screenshots from an example integrated numeracy learning environment that uses digital manipulatives and gamification mechanisms;

FIG. 9 is a screenshot of an example musical sequencer using digital manipulatives;

FIG. 10 is an example single social feed interface that integrates numeracy and literacy apps;

FIGS. 11A and 11B illustrate example sharing mechanisms for sharing current tasks with other users;

FIGS. 12A and 12 B illustrate example social features in which a user can search for a task and then post the task for other users;

FIGS. 13A-C illustrate additional example social features in which a user searches for a tasks then posts the task for other users;

FIGS. 14A and 14B illustrate example social features in which users may browse feeds of friends and perform similar activities;

FIG. 15 is a process flow diagram of an example method for presenting educational activities;

FIG. 16 is a block diagram of an example operating environment configured for implementing various aspects of the techniques described herein; and

FIG. 17 is a block diagram showing example computer-readable storage media that can store instructions for presenting educational activities.

### DETAILED DESCRIPTION

Currently, social media feeds are used to deliver content to audiences that are generally literate. However, there are approximately 250 million children globally who cannot read, write, or understand basic numbers and arithmetic. The majority of these children reside in developing countries that do not have consistent access to quality schools or teachers. As programs work to build schools and train teachers to provide education to children in these areas, there is a need for approaches to supplement learning in the meantime.

Technology provides a foundation for one such approach, which, unlike traditional infrastructure-dependent approaches, can be scaled to serve large populations and provide some form of fundamental education. Yet, the question of what types of technology can consistently engage children in these contexts, be localized to be culturally appropriate, bootstrap use by novice, preliterate, and illiterate users, facilitate learning in the absence of instructors, and overcome other infrastructural challenges is still an open problem.

Embodiments of the present techniques described herein provide a system, method, and computer-readable medium with instructions for presenting educational material. In particular, an extended social media feed may be used to present activities with information about what activities within the software other students have completed. For example, the other students may be friends or classmates of a user. The news feed can be constructed such that activities within the student's zone of proximal development are more likely to be shown. As used herein, a zone of proximal development refers to a level of challenge that is based on a user's historical activity. For example, presenting activities that are rated within a user's zone of proximal development may present an appropriate challenge level for a user that teaches the user something new, without being too hard such that the user is discouraged. In some examples, selecting an item from the news feed can allow a student to try the same educational activity as another student. The extended social media feed can also allow students to collaboratively work on a suitable activity. The choice of what to show in the extended social media feed may be based on any suitable pedagogical choices as well as on social factors. For example, the pedagogical choices may include the user's learning level or zone of proximal development, spaced repetition, topical coverage, etc. The social factors may include sharing of activities by close friends, sharing of activities by a teacher or mentor, etc. These two factors may mutually influence what is shown in the extended social media feed. For example, posts from friends may be ranked and/or shown or hidden based on their match to the target user's zone of proximal development. In some examples, the extended social media feed can be implemented as a tablet application that enables preliterate children to explore a stream (or “feed”) of educational activities, select and complete these activities, and then share them with their peers digitally.

Advantageously, the present techniques may be used to improve the reading level of users with very limited or nonexisting literacy skills. Moreover, the present techniques may enable users with limited skills to teach themselves how to read, write, and make mathematical. The present techniques thus improve children's engagement with educational software and thus the pedagogical benefit from educational software generally. Additionally, since the target for educational applications are often pre-school or elementary-aged children with no or weak reading skills who are using the apps to improve those skills, the interface is designed to be usable without literacy knowledge more specifically. Thus, users may be able to self-direct their engagement with the system and be motivated by digital sharing, while social context surrounding the system in physical space further motivates the users to learn.

Thus, the system may be usable without preexisting literacy. For example, the system may be used by a target population of children developing English literacy skills. The system may engage the students with several types of educational content to build basic literacy skills. Furthermore, the system can show users content within their skill level, also referred to herein as a zone of proximal development (ZPD). Within their ZPD, learners can complete relevant tasks with appropriate guidance, also referred to herein as scaffolding. Scaffolding tasks within a user's ZPD may ensure that engagement and learning will not suffer from the tasks being too easy, while both the system and other users can provide scaffolding for the activities as the activities advance in difficulty. Finally, the system can enable users to share activities with their peers. Sharing may happen in digital space through the software or in physical space due to the shape and size of the tablets that users may use. Sharing may thus be included to enhance engagement with the system via the beneficial incentives and the effects of peer learning.

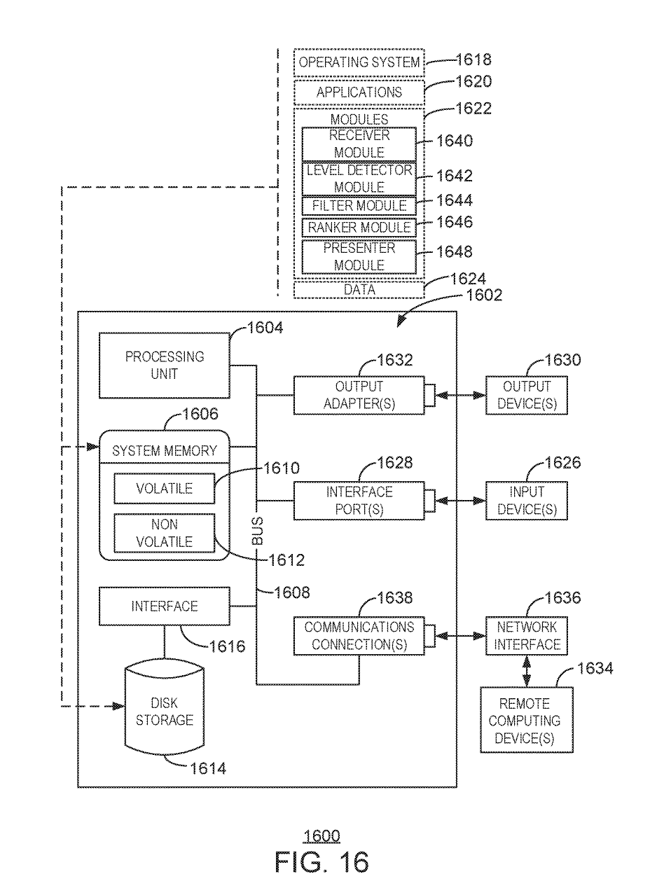

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 16, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. Moreover, computer-readable storage media does not include communication media such as transmission media for wireless signals. In contrast, computer-readable media, i.e., not storage media, may include communication media such as transmission media for wireless signals.

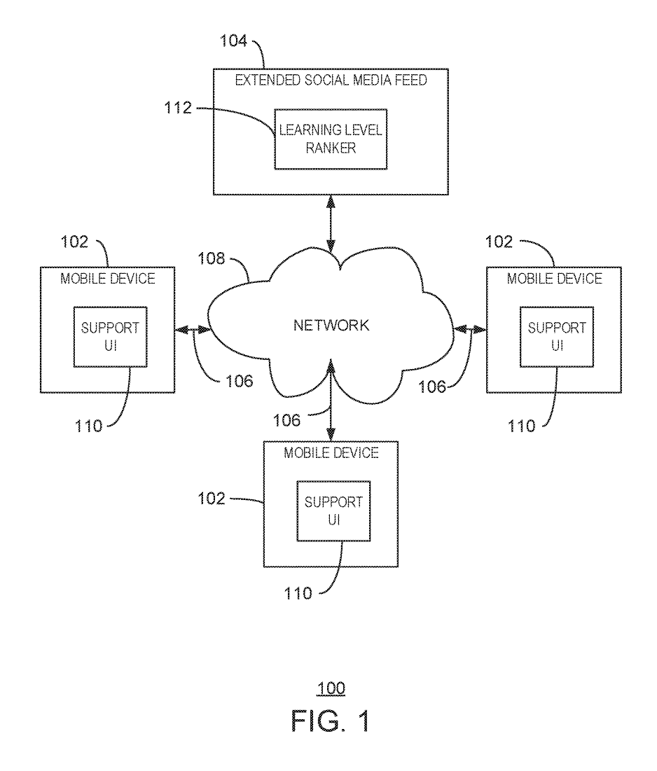

FIG. 1 is a block diagram of an example system 100 for presenting educational activities. The system 100 includes a number of mobile devices 102 coupled to an extended social media feed 104 via connections 106 to a network 108. The mobile devices 102 each include a support user interface (UI) 110. The extended social media feed 104 includes a learning level ranker 112.

In some examples, the system 100 may be a computer-supported collaborative learning (CSCL) and information and communication technologies for development (ICT4D) system that includes adapting algorithmic social feed mechanisms to be suitable for early childhood education and a population of preliterate users, among other possible users. The system 100 may enable educational activities with designs customized for educational purposes, and a presentation paradigm and interaction style tailored to these populations and goal sets. For example, the system may provide a social learning experience for preliterate children with no familiarity with the concept of an extended social media feed 104. In some examples, the system 100 may be customizable by administrators or end-users to fit any suitable purpose. For example, the system 100 may include access control, sign-in into ‘tasks’, ‘challenges’, competitions, etc., that a teacher, a parent or kids themselves can set up.

In some examples, the system 100 may utilize particular protocols and interactions. For example, the system 100 may utilize dynamic content and input within HTML or XML pages. In some examples, the system 100 may utilize cloud-based and remote-app supported interactions.

As shown in FIG. 1, the extended social media feed 104 may include a learning level ranker 112 to determine a learning level for each of the users of mobile devices 102. For example, each user may have an account used to sign into the extended social media feed 104 via a mobile device 102. For example, a user identifier may be assigned to a user when a new account is created. In some examples, the user identifier may be a picture of the user that is taken during setup, a biometric that is taken during setup, or a username/password, among other suitable forms of user identification. The user identifier may be associated with a learning level for each subject to be included in the education activities. For example, the subject may be literacy, or numeracy, among other subjects. In some examples, the system 100 may include a tablet application that may include of a number of activities that can be accessed and shared with peers through the extended social media feed 104. For example, the tablet application may include the support UI 110. For example, the activities may include Letter Recognition (“starts with”), Spelling, Fill-In-The-Blanks sentences, Jokes with touch-to-speak, Pattern Completion, Addition, Subtraction, Place Value, Multiplication, and Educational Videos, among other suitable educational activities. In some examples, each activity can give users opportunities to practice a particular basic numeracy or literacy skill. Numeracy skills may include number identification, addition, subtraction, and multiplication. Literacy skills may include letter identification and word recognition. In some examples, to make content accessible and learnable by preliterate children, directions and content may be spoken aloud by the system in English or any other suitable language. The system 100 may play the audio automatically when a user enters into an activity. In some examples, the audio may be replayed by the user by tapping on a speaker icon or on the words or numbers in the activity.

In some examples, the system 100 may be implemented as an application built with web technologies. For example, the system may be implemented with each activity implemented as a web component. In some examples, the system 100 may be implemented using any suitable mobile web application framework that enables web applications to be deployed as native mobile applications. In some examples, the application can be used in landscape mode with one user per mobile device 102. For example, the mobile device 102 may be a tablet. In some examples, activity synchronizing between tablets may be accomplished by having a local server running a database application instance that replicates a database between the tablets, allowing real-time activity sharing to work in the absence of Internet access.

In some examples, the system 100 may include support UIs 110 to make the system 100 usable without requiring literacy. For example, the extended social media feed 104 and activities may be designed with an education expert and may incorporate graphical elements, touch input, and audio output into the support user interface 110. For example, the support UI 110 may be similar to other user interfaces for low-literate and illiterate adult communities. Thus, children may be able to access and use the system. Moreover, hearing and seeing English words may be educationally beneficial, as multiple modalities may be important for second language learning. In some examples, users may thus wear headphones to interact with the system. In some examples, physical collaboration may be prioritized as a meaningful and engaging aspect of the system 100. In some examples, either of these experiences may be emphasized, and the system 100 can thus be designed to support both audio and co-located collaboration.

In some examples, activities may be received at the extended social media feed 104 from any of the mobile devices 102. In some examples, the activities may include activities that may be locally loaded onto the computing device hosting the extended social media feed 104. The extended social media feed 104 may then include one or more of the activities in one or more social media channels. In some examples, once content including activities is injected into a social media channel it can be shared based on permissions. For example, depending on licensing of the content, publishers may not allow unrestricted distribution of the content. In some examples, educators may want to make a selection of content and know exactly who was involved in the task because it may be part of the team work that has to be assessed and graded. Thus, in some examples, the extended social media feed 104 may also include an interface for educators to manually select and review content.

In some examples, recreational reading may be encouraged using scaffolded activities. For example, the activities may be interactive comics. The scaffolding may include automatically reading the text to the user as soon as the user scrolls or flips to the appropriate section of the comic or picture book. In some examples, the system 100 can highlight each word as the word is said to reinforce reading direction and the association between words and sounds.

In some examples, scaffolding can be gradually removed in the recreational reading process as a user becomes increasingly experienced with the process. For example, the system 100 may gradually remove scaffolding by not automatically playing the sound upon flipping to a new page, and instead indicating to the user they should tap the text bubble to play audio corresponding to the text. In some examples, scaffolding may be gradually removed by playing individual sentences instead of playing a whole text bubble. For example, the system 100 can include bubble-like affordances for clicking the sentences; this may reinforce the notion of sentence-level segmentation. In some examples, scaffolding may be gradually removed by providing the voice-synthesis scaffolding at the level of phrases instead of whole sentences. In some examples, scaffolding may be gradually removed by providing voice-synthesis scaffolding at the level of words instead of phrases. In some examples, at appropriate points of the story, the system 100 can insert an exercise that reviews some word or phrase that appeared in the preceding section that the user just read. For example, at the end of a comic, or at chapter breakpoints for manga-style comics, the system 100 may show a section and text bubble that the user had just previously seen. For example, the section may have a blank for a word. The user may thus choose the appropriate word that should go in the blank. In some examples, for a more difficult task, the user may actually write out the word. In another example, the system 100 can show a section and text bubble that the user may have just seen. For example, the system may have a blank for a phrase or a sentence. The user may then choose the appropriate phrase or sentence that should go in the blank from a list of options. In yet another example, the system can show a section and text bubble that the user had just seen. The section may have a blank for a letter in a word. The user may thus write out the appropriate letter that should go in the blank.

The diagram of FIG. 1 is not intended to indicate that the example system 100 is to include all of the components shown in FIG. 1. Rather, the example system 100 can include fewer or additional components not illustrated in FIG. 1 (e.g., additional extended social media feeds, networks, mobile devices, etc.). In addition, examples of the system 100 can take several different forms depending on the location of the extended social media feed 104, the location of the mobile devices 102, etc. In some examples, multiple extended social media feeds 104 may operate in parallel.

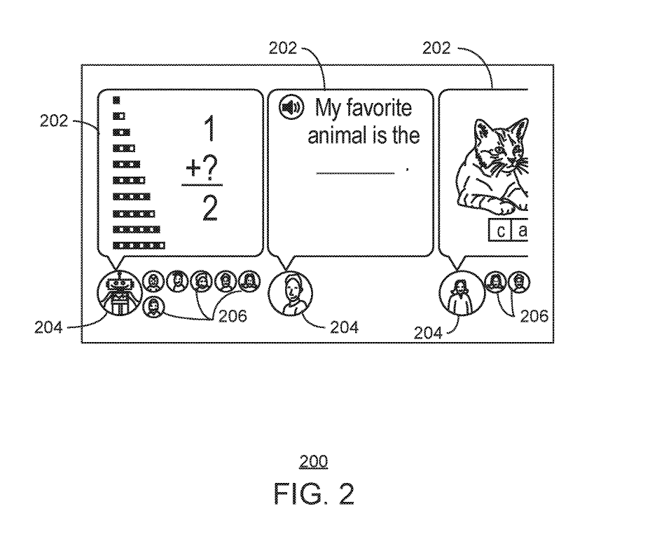

FIG. 2 is an example extended social media feed that can present educational activities. The example social feed is generally referred to using the reference number 200 and can be presented on the mobile devices 102 of FIG. 1 or be implemented using the computing device 1602 of FIG. 16 below. For example, the computing device 1602 may stream the activities to the mobile device 102, which may receive user input, collect input, and forward the input to the computing device 1602 for analysis of the history of engagement, and calculation of learning levels, among other processing.

As shown in FIG. 2, the social feed 200 includes bubbled thumbnails of social activities 202. The social feed 200 also includes circular thumbnails of activity sources 204. Furthermore, the social feed 202 includes smaller circular thumbnails of peers 206.

The social feed 200 displays thumbnails of available activities 202 and the sources 204 that shared them with the user. For example, the sources 204 may include an algorithmic selection of an activity by the extended social media feed 104 itself as indicated by a robot avatar, or another user as indicated by an avatar displaying a picture of the user. In some examples, educational content including the activities within the social media feeds can come from publishers, schools, parents, or students, among other suitable sources.

In the example of FIG. 2, the social feed 200 displays the available activities from left to right, in order of how recently they were added, and uses a side-scrolling interface to enable users to navigate through the list. In some examples, the social feed may have a left-to-right direction, as opposed to the top-down direction, both to match the left-to-right reading direction of English as well as to make the feed suitable for use in landscape mode. For example, the additional horizontal space may be more suitable for some activities, such as typing activities. The social feed 200 also shows smaller thumbnails of each of their peers 206 who already completed the activity. For example, the peers 206 may be classmates. In some examples, the peers 206 may also include teachers that may have recommended particular activities. The indication of completion can potentially serve as a signal that an activity is enjoyable and popular. Thus, activities 202 shown in the social feed 200 can come from either the user's peers, the teacher, or an algorithmic selection of the social feed 200.

In some examples, when a student successfully completes an activity, the social feed 200 may replace that activity in the user's social feed with a new activity or activities. For example, the social feed 200 may add one new activity to the feed of the same type as the completed activity but with new content, in order to promote depth of one skill. This may ensure that the added activity has new content that is within a user's zone of proximal development, as determined by their completion of the prior activity. Specifically, the social feed 200 may select this new activity algorithmically by assigning a difficulty level to each individual exercise within an activity type, and selecting a new exercise that increments this difficulty level. For example, for the addition task, addition of smaller numbers may be an easier and more basic task. Therefore, addition of smaller numbers may have a lower difficulty level and may be suggested first. In some examples, there may be only one exercise per level. In some examples, multiple exercises may be provided per level. In some examples, the social feed 200 can alternatively add one new activity that is a different type from the completed activity, in order to promote breadth of skills. In another example, the social feed 200 may use a combination of the above—adding one new activity of the same type as the completed activity but with new content, and also one new activity of a different type. In some examples, the social feed 200 may only suggest problems that are more difficult once easier activities have been completed. For example, such progression of difficulty may be performed in accordance with the principles of mastery learning and ZPD. For larger exercise sets, the social feed 200 algorithm may be modified so that a student may complete a particular number of exercises at a target difficulty level before advancing to the next level.

In some examples, the system may present educational activities for preliterate users that work well within the paradigm of an educational social feed 200. For example, a variety of types of educational exercises may be included for practicing both numeracy and literacy skills on tablets. These activities may illustrate designs for making content appropriate to a preliterate audience. For example, the activities may involve the use of audio cues and simulation of physical manipulatives. In addition, the activities may be performed without teacher direction. For example, new activities may start by providing an audio and video tutorial. The activities may also include a social feed paradigm. For example, the activities may include progressive leveling of content within an activity type, social incentives for sharing, and building up on content.

In some examples, coordinators such as teachers may be provided an ability to push particular content to a student. For example, the teacher may decide that a particular activity may be beneficial for a student and push the activity to the student's mobile device. The mobile device may then display the pushed activity for the student to complete. In some examples, an avatar may be included to indicate that the teacher is the source of the pushed activity. For example, the avatar may be a picture of the teacher or an icon of a teacher.

The diagram of FIG. 2 is not intended to indicate that the example social feed 200 is to include all of the components shown in FIG. 2. Rather, the example social feed 200 can include fewer or additional components not illustrated in FIG. 2 (e.g., additional activities, sources, peers, etc.).

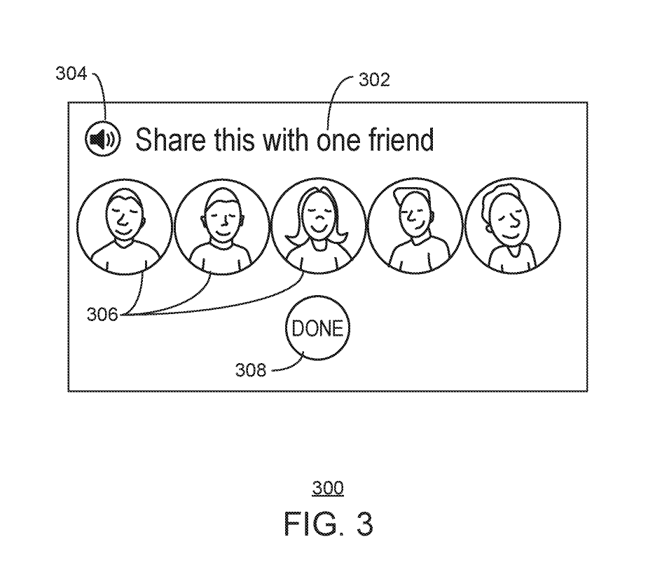

FIG. 3 is an example sharing screen for sharing a completed activity with a friend. The sharing screen is generally referred to by the reference number 300 and can be presented on the mobile devices 102 of FIG. 1 using the computing device 1602 of FIG. 16 below. For example, the computing device 1602 may stream the activities to the mobile device 102, which may receive user input, collect input, and forward the input to the computing device 1602 for analysis of the history of engagement, and calculation of learning levels, among other processing.

The sharing screen 300 includes a sharing instruction 302, an audio button 304, a set of pictures 306 of peers to share with, and a completion button 308. As shown in FIG. 3, upon completing an activity, users may be shown a screen where they can choose to share the activity they have just completed with a peer 306. The screen 300 shows the pictures 306 of the peers, and reads aloud instructions 302 to share the activity with one friend in response to the pressing of the audio button 304. In some examples, once the user has selected a peer to share the activity with, the activity may be shared with the selected peer in real-time. In some examples, the activity may then appear at the start or left-hand terminus of the selected peer's feed. In some examples, the activity may appear in the selected peer's feed independent of what learning level the selected peer may have in the subject corresponding to the shared activity.

In some examples, the peer-shared activities can be modified to focus on ZPD so that the content is at the selected peer's current learning level in any given subject. Alternatively, the social feed may wait to display these shared activities until the selected peer reaches the appropriate learning level. In some examples, the system may implement simple, real-time sharing for a limited number of exercises. Real-time sharing may be accomplished by having each of the tablets sync to a database that stores a list of activities that should be displayed. In some examples, the sharing may be mediated by a local server via Wi-Fi. In some examples, shared tasks may appear to users when developmentally appropriate via a sophisticated Intelligent Tutoring System (ITS). In some examples, activities that are more creative may be included for collaboration and remixing between users. Thus, the activity performed by different users may differ depending on work performed by previous users.

The diagram of FIG. 3 is not intended to indicate that the example sharing screen 300 is to include all of the components shown in FIG. 3. Rather, the example sharing screen 300 can include fewer or additional components not illustrated in FIG. 3 (e.g., additional peers, instructions, etc.).

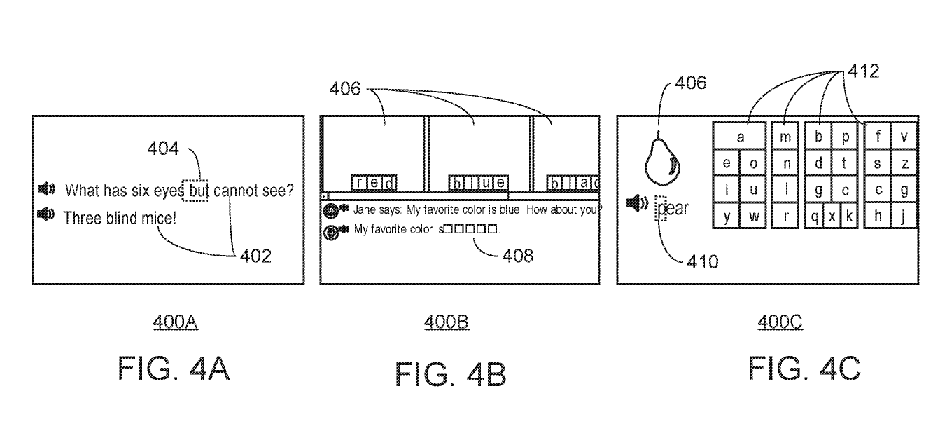

FIGS. 4A-C illustrates example literacy activities that can be presented. The example literacy activities are referenced using the reference numbers 400A, 400B, and 400C and can be presented on the mobile devices 102 of FIG. 1 using the computing device 1602 of FIG. 16 below. For example, the computing device 1602 may stream the activities to the mobile device 102, which may receive user input, collect input, and forward the input to the computing device 1602 for analysis of the history of user engagement, and calculation of learning levels, among other processing of the user input.

As seen in FIGS. 4A-C, various types of activities for reading and writing skills may be presented. For example, a basic reading activity may focus on skills such as word segmentation and how words can be organized into sentences that are separated by spaces and read from left to right. As shown in FIG. 4A, in some examples, a set of short sentences 402 may be read aloud via speech synthesis with the social feed highlighting 404 each word as it is spoken. In some examples, users can tap on a word to hear it in isolation, or have the entire sentence 402 read aloud. The sentences 402 may be chosen from a corpus of passages that may be meant to be read by children, such that the sentences 402 are easily decodable and contain content that is targeted towards children. In some examples, the material may be appropriate to the age and culture from which the learner is from, such that there is no obstacle to comprehension beyond just literacy. In some examples, if a user is not able to recognize a word, the meaning of a word may be easy to infer from its context. For example, readers may be able to infer meaning of words via pictorial context clues 406 and textual clues. For example, if a sentence reads “Jamie hit the shuttlecock over the net, and scored a point because Kim missed it with his racquet,” even if a reader is not familiar with the rare word “shuttlecock,” they can infer its meaning from the context. The reader may not know that a shuttlecock is a rubber ball with feathers attached, but the reader may grasp that a shuttlecock is a projectile involved in a game, and may likely perform some kind of memory search to compare it to known games, such as soccer ball, cricket, or informal games involving a projectile.

In some examples, scaffolds may be provided to reduce the difficulty of the task to a level appropriate to the student's current skills. For example, scaffolds may include restricting the task to filling in a single word, or providing a list of options for words that can be used to fill in the blank 408. In some examples, scaffolded comics may be used to foster recreational reading habits. In some examples, scaffolding may be gradually removed in the recreational reading process as the user becomes increasingly experienced with the process. For example, the social feed may not automatically play the sound upon flipping to the new page, and instead indicate that the user should tap the text bubble to play the text. In some examples, instead of playing the whole text bubble, the social feed may make users play individual sentences. For example, the social feed may have bubble-like affordances for clicking the sentences. This may reinforce the notion of sentence-level segmentation. In some examples, instead of whole sentences, we provide the voice-synthesis scaffolding at the level of phrases. In some examples, instead of phrases, we provide the voice-synthesis scaffolding at the level of words. In some examples, the system can insert an exercise at appropriate points of a story that reviews some word or phrase that appeared in the preceding section of the story that was just read. For example, the appropriate point may be at the end of a comic or at chapter breakpoints for manga-style comics.

In some examples, social activities may be designed to enable children to share text with each other to stimulate peer-learning and reinforce the social feed paradigm. For example, FIG. 4B illustrates a social writing exercise in which a student sharing an activity via the social feed can display their answer to a question, deepening the social incentives in completing the writing task.

In some examples, literacy-skill activities can involve typing letters. For example, as shown in FIG. 4C, basic-level activities may involve typing the first letter 410 of a word. The social feed may ask the user to “type ‘p’ as in ‘pear’”In some examples, as shown in FIG. 4B, a more advanced activity may have users type an entire word indicated by blanks 408. In some examples, targeting a preliterate audience may involve a special keyboard design 412 to scaffold the process of learning how to type letters. For example, FIG. 4C shows a keyboard 412 that is phonetically arranged, grouping together letters that represent similar phonetic sounds into color-coded blocks. In some examples, the position and color of each key in the keyboard 412 can be designed to reflect the phonetic properties of the letter, providing an additional cue to help the users remember letters' sounds. In some examples, the system can also pronounce the sound of the letter that is touched as a further reinforcement. In some examples, to help scaffold users in the task of learning to type words, the users may first start by seeing only a portion of the keyboard 412, one letter at a time. As the users progress, more letters may become available at once, eventually leading to typing specific letters from the entire keyboard 412. In some examples, an incorrect entry may trigger a visual and audio cue and restart the progressive keyboard 412 process. In some examples, difficulty levels may be assigned to words based on the number of new letters that the learner has not yet covered. In some examples, the system may also prioritize words that are “decodable.” For example, decodable words may lack letters that are silent or have a sound that is different from the normal sound of a letter. Words with letters that are silent or make different sounds might otherwise make the process of spelling by sounding out the word more difficult for beginners. In some examples, the assignment of difficulty levels may be used to allow the social feed to factor ZPD into account in content selection.

The diagrams of FIGS. 4A-C are not intended to indicate that the example set of literacy activities 400A, 400B, and 400C are to include all of the components shown in FIGS. 4A-C. Rather, the example set of literacy activities 400A, 400B, and 400C can include fewer or additional components not illustrated in FIGS. 4A-C (e.g., additional words, keyboards, audio buttons, etc.).

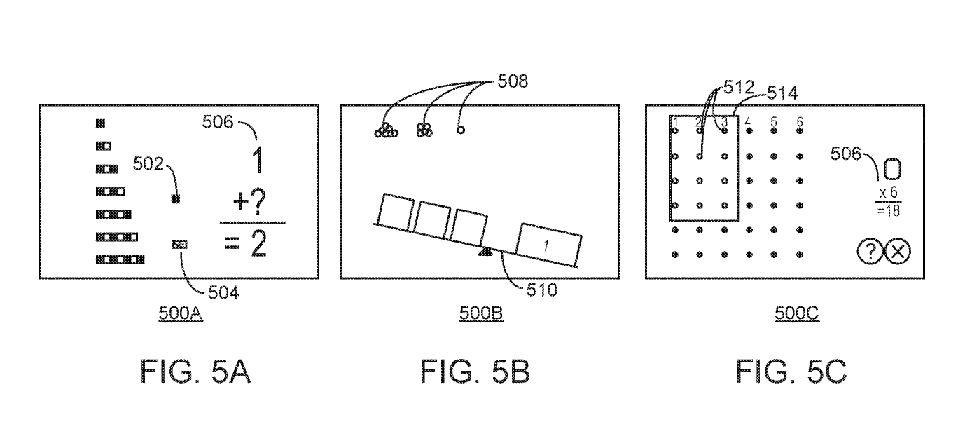

FIGS. 5A-C illustrate example numeracy activities that can be presented. The numeracy activities are generally referred to using the reference numbers 500A, 500B, and 500C and can be presented on the mobile devices 102 of FIG. 1 using the computing device 1602 of FIG. 16 below. For example, the computing device 1602 may stream the activities to the mobile device 102, which may receive user input, collect input, and forward the input to the computing device 1602 for analysis of the history of engagement, and calculation of learning levels, among other processing.

As shown in FIGS. 5A-C, various types of numeracy activities may presented to users. In some examples, the numeracy activities may be digital analogues to manipulatives used in Montessori curricula. In some examples, activities can be selected that are particularly well suited for touch interactions. For example, the numeracy activities may rely on dragging visual elements in space to select the visual elements, sort the visual elements, or stack the visual elements in order to understand the concepts of numbers and multi-digit numbers, and to learn addition, subtraction, and multiplication. As shown in FIG. 5A, the bar activity can emphasize the concept of number by analogy to bar lengths. Several bars can be labeled with numbers corresponding to their lengths, and the user may be requested to order them in increasing order of length. The number may be read aloud when the user interacts with the corresponding bar to reinforce the association between the bar length, the symbol for the number, and the number's pronunciation. The example addition activity shown in FIG. 5A may extend this length metaphor by having users add a missing bar to an existing bar 502 to reach a desired target length 504. In addition, a formula 506 is displayed on the right to show the correspondence between the symbolic representation and the bar-lengths representation of the addition formula. Similarly, a subtraction activity may involve having users add “negative” bars to an existing one, to reach a lesser target length. The formula 506 may be displayed on the right to indicate a correspondence between the symbolic representation and the bar-lengths representation of the subtraction formula.

As shown in FIG. 5B, the balance activity may focus on how to identify multi-digit numbers by having users drag items 508 that are in groups of 1, 10, or 100 onto a balance 510 to match a number. This may be similar to the Montessori-inspired BEAM system for teaching arithmetic, but may have a simplified interface that stresses the association between quantities and the symbolic representations of the numbers.

As shown in FIG. 5C, a multiplication activity may use a grid of dots to highlight the concept of multiplication via an area analogy. A user can select dots 512 via a rectangular box 514, and the dots selected 512 may equal the number of columns multiplied by the number of rows. In some examples, a voice can read out the current product whenever the number of selected dots 512 changes. In some examples, the multiplication activity may begin with a free-play version where the user can experiment with the grid and observe the corresponding formula 506 on the right. In some examples, the number of bars, the number to match, and the size of the grid may increase with progressively higher difficulty levels.

The diagrams of FIGS. 5A-C are not intended to indicate that the example set of numeracy activities 500A, 500B, and 500C are to include all of the components shown in FIGS. 5A-C. Rather, the example set of numeracy activities 500A, 500B, and 500C can include fewer or additional components not illustrated in FIGS. 5A-C (e.g., additional blocks, formulas, dots, etc.).

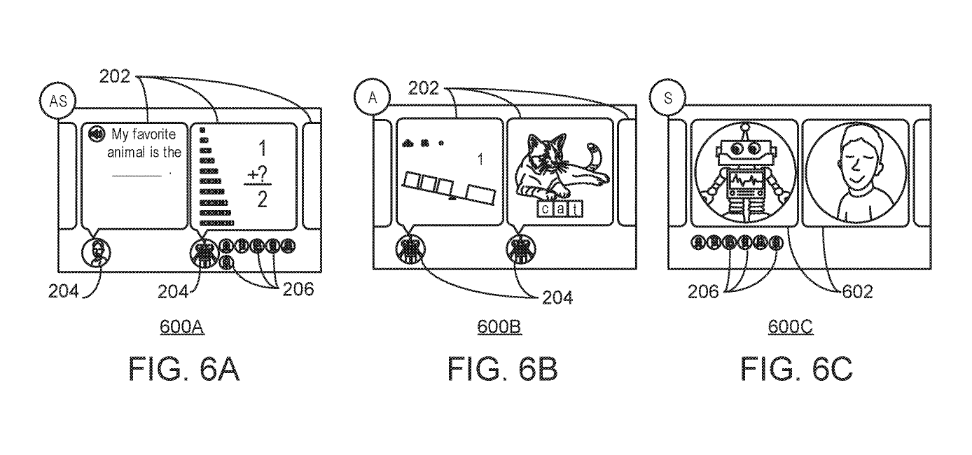

FIGS. 6A-C illustrate example feed variants that can be used to display educational activities. The three example feed variants are generally referred to using the reference numbers 600A, 600B, and 600C and can be presented on the mobile devices 102 of FIG. 1 using the computing device 1602 of FIG. 16 below. For example, the computing device 1602 may stream the activities to the mobile device 102, which may receive user input, collect input, and forward the input to the computing device 1602 for analysis of the history of engagement, and calculation of learning levels, among other processing.

As shown in FIGS. 6A-C, several variants 600A, 600B, and 600C of the social feed may be used. The variants 600A, 600B, and 600C may include the same underlying educational activities 202, but may present the activities 202 to users differently. In some examples, all variants may display a maximum predetermined amount activities to keep choices manageable for users. For example, a maximum number of 10 activities may be ordered from the most recent on the left to the oldest on the right. Once completed, activities may be removed from the feed to make room for more recent activities queued in the database as suggested by the system or peers.

As shown in FIG. 6A, a first variant 600A may be both activity- and sharer-driven (AS). For example, this variant 600A may be the main prototype design that was presented in the example social feed 200 of FIG. 2 above. As described, this feed displays activity content in thumbnails and may be sharing-enabled.

A second variant 600B may be an activity-driven (A) variant. For example, the second variant 600B may have the sharing component of variant 600A removed. Thus, all activities may be suggested by a robot. For example, the robot may be an algorithmic suggestion of new activities of the same type as prior completed activities may be based on the user's zone of proximal development. Users may not able to share activities with their peers, and there may be no indication of other users completing activities. This variant 600B may encourage purely physical collaboration via the tablets in the classroom, as opposed to virtual or mediated collaboration through a social feed.

A third variant 600C may be a sharer-driven (S) variant. For example, the third variant 600C may have the ability to view activity content in the thumbnails removed. Instead, the thumbnails 602 may display large pictures of the person or robot that suggested or shared the activities. The sharer-driven version of the system may encourage digital sharing.

In some examples, for the sharing-enabled variants 600A and 600C of the system, a predetermined maximum of peer-shared activities may be displayed to ensure that activities suggested by peers, the teacher, and the robot are all represented in the feed at any given time. The remaining thumbnails may thus be teacher-shared and robot-shared activities. In some examples, all of these activities 202 may be displayed in order of recency of being added to the feed. In some examples, if two or more peers share the same activity 202 to the same user, the duplicate activities 202 would appear in the feed in order of recency. For example, the same activity may be an activity 202 of the same type with the same content. Once the user completed one of these duplicate activities 202, they would all be marked as completed and removed from the feed. In some examples, the number of choices on the activity sharing screen may be limited to a predetermined number of peers in the class. For example, four out of five peers may be randomly selected from the class. In some examples, to ensure that children always have at least one person they have strong ties with to choose from, children may be privately asked for the name of their best friend and always included that person in their list of sharing recipient options. Additionally, algorithmically selected activities in the sharing-enabled variants 600A and 600C of the system may be randomly assigned a robot. In some examples, the algorithmically selected activities may be assigned a picture of the classroom teacher.

In an experiment performed using 600A and 600C variants including activities suggested by peers, the children were particularly taken by seeing the faces of their classmates. The children were visibly excited when they saw their friends' and teachers' faces in the thumbnails of the feed in the sharer-driven variant 600C. They were also visibly excited to see their peers' faces when were asked to share the activity. The children were observed showing each other their faces on the screens and pointing at the faces. These students were consistently eager to finish activities so they could get to the sharing screen to see their classmates' faces as well. Quantitatively, students who used the activity-driven interface 600B, without any sharing, completed a mean of 69.4% of the activities they entered (SE=3.1%). Students who used the activity and sharer-driven interface 600A completed a mean57.2% of the activities they began (SE=3.1%). Students who used the sharer-driven interface 600C only completed an average of 46.0% of the activities that they started (SE=3.1%). These differences were also statistically significant (F(2, 67)=14.05, p<0.001, partial η2=0.295, 1−β=0.998); posthoc Bonferroni-corrected tests showed that each of the completion rates were significantly different from each other as well (p<0.05 for all three comparisons).

Observations corroborated this quantitative finding and indicated that students were attempting more activities and then not completing them when using the sharer-driven interface 600C because they were trying to find particular activities that they physically saw their peers playing or that the students knew they wanted to play. This was likely because in this variant 600C, children could not determine what an activity type or activity content was without opening it as thumbnails 602 only included the recommender. For example, one child chose to do an activity with his best friend's face as the thumbnail 602, but immediately exited when he realized that the activity that was recommended to him was not what his best friend was playing as he sat next to him, but rather something that was shared with him from earlier in the session. Because of this, children often asked the facilitating researchers how to find a particular activity their friend was playing since they could not tell which activity was which when using the sharer-driven interface. Therefore, digital sharing in the sharing-enabled variants of the system 600A and 600C was often overpowered by physical sharing, as physically seeing their friends completing activities was more motivating than seeing an abstract representation of their friend who shared an activity with them.

As mentioned in the prior section, the small tablets allowed for different configurations of children, including switching of devices and sitting in groups, which allowed them to collaborate in physical space in a way that is different from our concept of social feed sharing for adults. Thus, the physicality of the interactions appeared to be more important than the virtual social support that was built into the system. Along these same lines, it was unclear if the students understood the concept of virtual sharing or digital recommendations within the two sharing versions of the system. While they were excited about seeing their peers in the interface, no children gave evidence during the sessions that they grasped the fact that they were receiving or giving suggestions for activities. Sometimes virtual sharing was more obvious in real time. For example, one boy in a classroom using variant 600C played a literacy activity, finished the literacy activity, and then shared the literacy activity with his peer. His peer immediately received the shared literacy activity, chose the thumbnail 602 of the sharer's face, and started playing the shared literacy activity himself. Yet, most of the time, the shared activities did not immediately appear in their chosen peer's feed due to the limitation of the number of activities in the feed. By setting a maximum of peer-shared activities in a feed while the rest of the shared activities were queued, this sharing experience was not designed for immediacy on the receiver's end. Sometimes shared activities did not appear in the receiver's feed because that user had already completed that same activity, shared by a different peer or suggested by the system.

Similarly, children who used the activity- and sharer-driven 600A version of the system appeared to focus on the content and ignore the smaller, less noticeable faces 206 below the thumbnails corresponding to other peers who had done the activity. The children did not appear to understand the purpose of these smaller faces 206. The children tried to tap these faces and asked us why the buttons did not do anything. Thus, in some examples, smaller thumbnails 206 corresponding to other peers who have completed an activity may be removed.

The diagrams of FIGS. 6A-C are not intended to indicate that the example set of social feed variants 600A, 600B, and 600C are to include all of the components shown in FIGS. 6A-C. Rather, the example set of social feed variants 600A, 600B, and 600C can include fewer or additional components not illustrated in FIGS. 6A-C (e.g., additional activities, thumbnails, etc.).

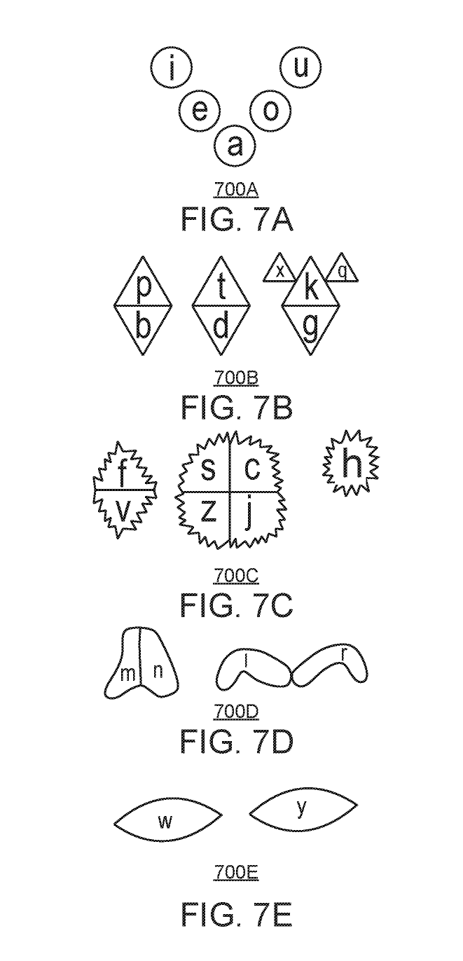

FIGS. 7A-E illustrate example featural keyboards that can be used to reflect phonological relationships between letters. The different examples of shapes are generally referred to using the reference numbers 700A-700E.

As shown in FIGS. 7A-E, a featural keyboard layout may be a keyboard in which the location and shape of the keys reflects their phonological properties may be used to reinforce the relationship between similar-sounding letters. For example, the Korean alphabet (Hangul) is quite easy to learn, because letters' shapes reflect their sounds—so similar-looking sounds have similar letterforms (thus a “featural+alphabet”). For example, g= [symbol] , k= [symbol] d= [symbol] , t= [symbol] etc. However, the Latin alphabet letter shapes cannot be modified to make them easier to learn. Thus, the keyboard layout can be modified to reflect phonetic properties of the letters via the key position or shape. This modification can reinforce the relationship between similar-sounding letters. This reinforcement can make key hunting easier.

For example, as shown in 700B, if a child forgets what the letter “P” looks like but remember that it sounds similar to the letter “B,” the child may find the letter “B” and “P” may be right next to the letter “B.” In some examples, the general phonological class that the letter belongs to may be used as an additional cue to remember the letter. For example, the general phonological class may include key shape or key area.

In some examples, the scaffolding may be gradually removed. For example, the system may gradually turn the keys into squares, and then rearrange the square keys into the standard keyboard order until the keyboard looks like a normal-looking QUERTY keyboard. In some examples, the system can make the appearance of the keys reflect the phonetic properties. For example, vowels can be circles, while consonants can be polygons. For example, the polygons may include features such as differing numbers of edges to make distinctions between nasals like “N,” fricatives like “S,” and stops like “P.” In some examples, additional visual properties such as the border of the keys can reflect properties such as voicing of consonants. For example, the letter “P” might be a plain triangle to indicate that it is an unvoiced stop. In another example, the letter “B” could be a triangle surrounded by a jagged or fuzzy border to indicate that it is a voiced stop. In some examples, colors can be used as yet another cue to group together letters that have similar phonological properties, and indicate the similarity of phonological classes via the similarity of the color. For example, vowels may be yellow, and semivowels like “Y” and “W” may be orange to indicate that they are related to vowels.

In some examples, as shown in 700A, vowels can be organized according to place of articulation. For example, vowel letters on the left may be front vowels as the tongue is at the front of the mouth when articulating their sound. In some examples, letters on the right may be back vowels as the tongue is at the back of the mouth when articulating their sounds. In some examples, vowel letters on the bottom may be open vowels as the tongue is at the bottom of the mouth. In some examples, vowel letters on the top are closed vowels tongue is at the top of the mouth.

As shown in 700B, in some examples, a first row of consonants may include stops. For example, stops may include consonants that have a single, big release of air. The shape of stops may be a triangle because they have a single point. In each pair, the top letter is unvoiced, and the bottom letter is voiced. For example, the letters “X” and “Q” are not sounds themselves, but grouped with the letter “K” since they both phonetically begin with a k sound.

In some examples, as shown in 700C, a second row of consonants may include fricatives. For example, fricatives may be consonants that have a constant release of air through a small obstruction. The shapes of fricatives may be fuzzy or hairy in appearance to indicate a constant release of air. In some examples, a top fricative may be unvoiced, and a bottom fricative may be unvoiced. For example, the letter “C” is not a sound itself, but grouped next to the letter “S” since the letter “c” may be phonetically “ts.” In addition, the letter “J” may not be a sound itself, but grouped next to the letter “Z” since they both often assume the [symbol] or d [symbol] sound.

In some examples, as shown in 700D, a third row of consonants may include nasals and approximants. For example, nasals, such as the pronunciations of the letters “M” and “N”, may be in the shape of a nose since they are characterized by air escaping through the nose. In some examples, approximants, such as the consonants “L” and “R,” may be in the shape of raised tongues since they are characterized by the tongue approaching the top of the mouth.

In some examples, a fourth row of consonants may include semivowels. For example, semivowels may include letters such as “W” and “Y.” In some examples, semivowels may be shaped like ovals because they are like vowels (shaped as circles) phonetically, but not quite.

The diagrams of FIGS. 7A-E are not intended to indicate that the example set of social feed variants 700A, 700B, 700C, 700D, and 700E, are to include all of the components shown in FIGS. 7A-E. Rather, the example set of social feed variants 700A, 700B, 700C, 700D, and 700E can include fewer or additional components not illustrated in FIGS. 7A-E (e.g., additional vowels, consonants, shapes, rows, etc.).

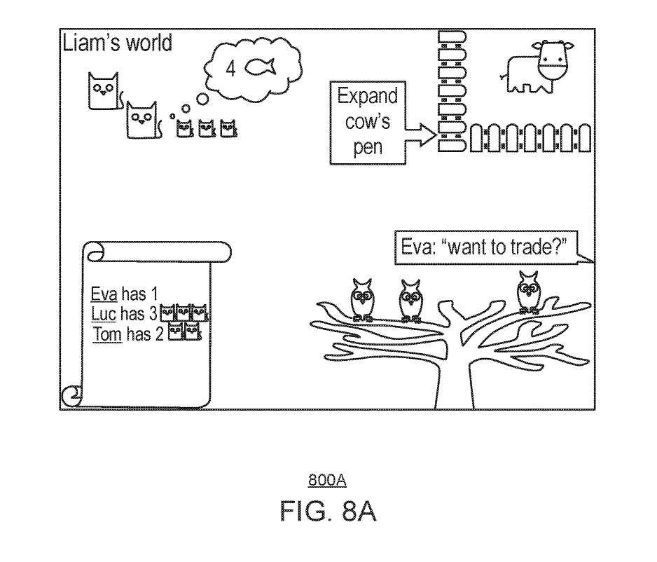

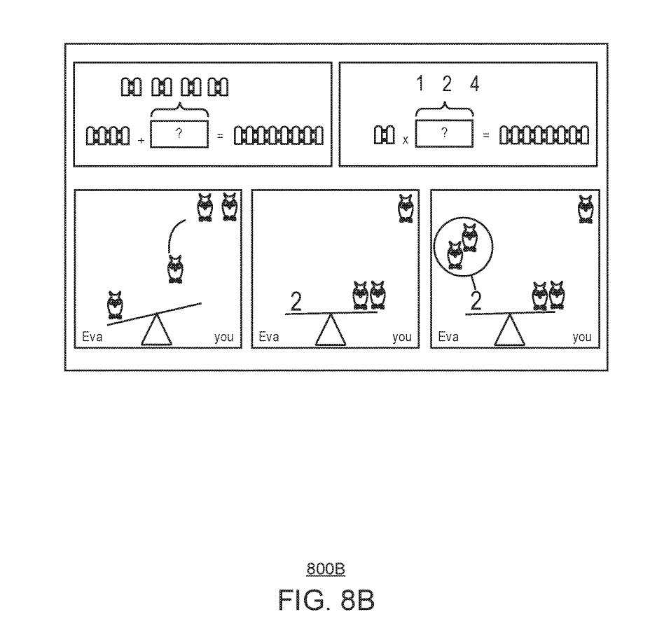

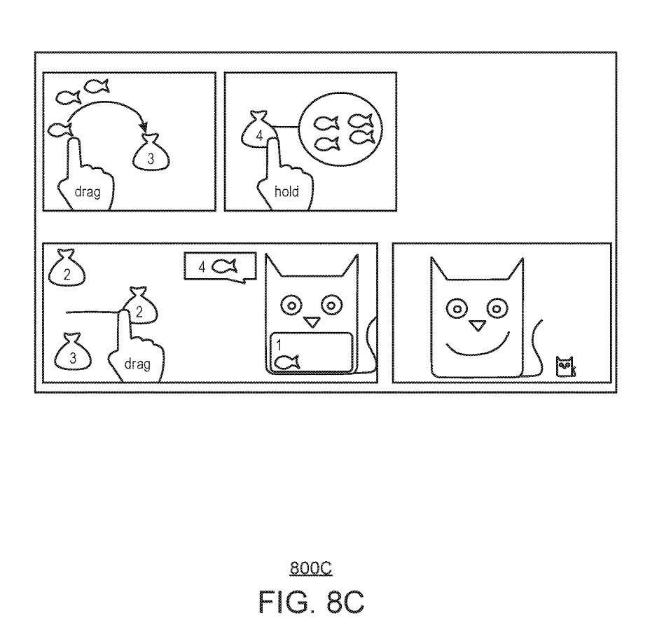

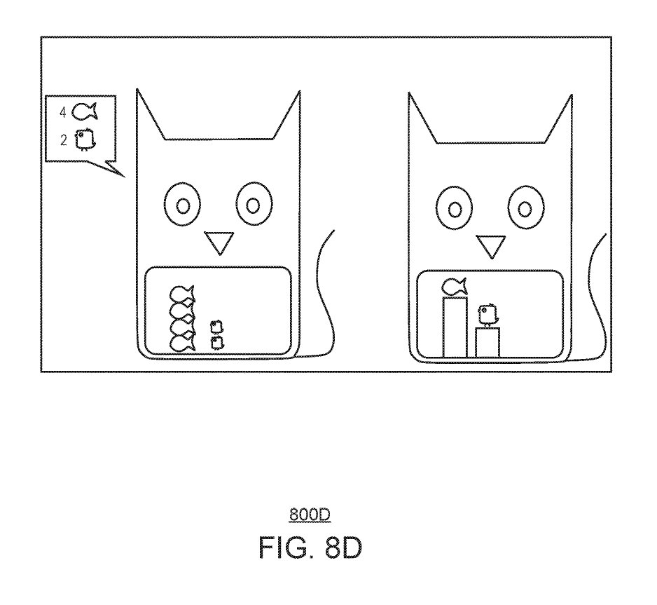

FIGS. 8A-8D are a set of screenshots from an example integrated numeracy learning environment that uses digital manipulatives and gamification mechanisms. The example screenshots are generally referred to using the reference numbers 800A-800D.

As shown in FIG. 8A, a virtual world can be used for learning. For example, game mechanics can be inspired from world simulator games. In some examples, tasks may be rewarded with objects or animals. In some examples, students may be able to feed animals, build shelters, and trade animals by completing numeracy activities. In some examples, each type of animal may correspond to a type of competency. The completion of more complicated tasks may result in better rewards. In some examples, simple tasks can be performed many times to receive more rewards. In some examples, popular game mechanics may be used to emphasize and support social (peer) learning. In some examples, a social news feed can be used. For example, the social news feed may be asynchronous on multiple devices over longer periods. In some examples, multiplayer tasks may be synched on the same device. In some examples, social cooperative quests synched on multiple devices can be used to introduce cooperation between students. For example, students may be able to visit worlds built by other students.

As shown in FIG. 8B, in some examples, students may be able to build shelters. For example, numeracy activities may include lengths of fencing to be added to complete a fence. In some examples, students may be able to trade animals. For example, two red owls may be traded for two orange owls to teach students the concepts of balancing equations.

As shown in FIG. 8C, in some examples, students may prepare food by dragging fish into a bowl. For example, a predetermined number of fish may be needed to satisfy the appetite of a cat. In some examples, the student may be able to drag fish into a cat's stomach to feed the cat. The system may then reward the student by showing growth of the cat or via the breeding of additional cats.

As shown in FIG. 8D, in some examples, gamification can be used to teach the concept of charts. For example, discrete numbers of items such as the fish and birds of screenshot 800D may be represented in bar chart format.

The diagrams of FIGS. 8A-8D are not intended to indicate that the example integrated numeracy learning environment depicted in the screenshots 800A, 800B, 800C, and 800D, is to include all of the components shown in FIGS. 8A-8D. Rather, the example integrated numeracy learning environment depicted in screen shots 800A, 800B, 800C, and 800D, can include fewer or additional components not illustrated in FIGS. 8A-8D (e.g., additional activities, animals, feeds, etc.).

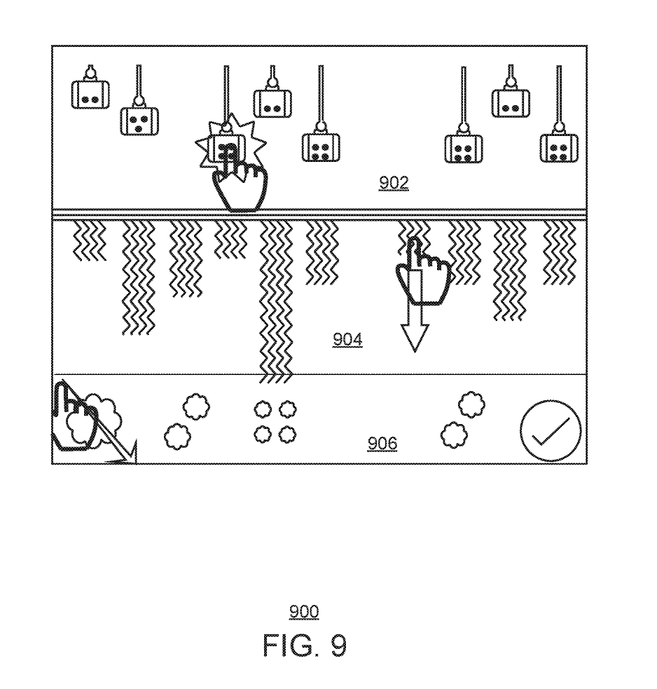

FIG. 9 is a screenshot of an example musical sequencer using digital manipulatives. The screenshot is generally referred to using the reference number 900.

In FIG. 9, each instrument in the sequences may be connected to a Montessori-style or Waldorf-style manipulative task to teach a different mathematical skill. In some examples, after enough success in these tasks, students may be allowed to create a composition using digital manipulatives as instruments. Digital manipulatives can include any of various virtual objects or materials that students can interact with in order to help them learn mathematical and other concepts. For example, a digital manipulative may be the digital bar 502 described in FIG. 5A, where students can manipulate visual bar length to grasp the concept of numbers, and compare or sort numbers. By considering this manipulative as an instrument that provides an audio feedback with a specific sound timbre as an analogy with musical instruments, learning a mathematical competency with students interacting with each other then becomes like playing a musical instrument. Thus, students may create artefacts from their learning that serve as personal rewards. In some examples, the students may also be able to share the artefacts with other students. For example, the artefacts may be musical pieces. In some examples, as more competencies are acquired, students can then build an orchestra of several instruments and compose more complex pieces. For example, the students can build an orchestra of several instruments, each instruments associated with different mathematical competency. These compositions may be the reward for completing learning tasks. In some examples, the students can then share their music with peers via local network, hear one another's work, add parts to other compositions, or remix other compositions.

As shown in FIG. 9, an orchestra including three instruments 902, 904, 906 may have been acquired by students as the students completed three numeracy exercises. In some examples, the students can compose a musical piece by interacting with each of these instruments and adjusting their pitch. For example, a piece may be played from left to right, with each horizontal track generating a musical note for a specific instrument.

The top instrument 902 may use an analogy of weights of bags to grasp number sense. For example, a specific timbre may be associated with bags, with the content of each bag defining its pitch. The middle instrument 904 may use an analogy of lengths of bars to grasp number sense. For example, a different timbre may be used here, with different lengths defining different pitch. Finally, the bottom instrument 906 may use an analogy of dividing a shape into parts of different sizes to teach concepts of addition. For example, a different timbre may be used for the bottom instrument 906 and number of different shapes may define different pitches.

The diagram of FIG. 9 is not intended to indicate that the example musical sequencer 900 is to include all of the components shown in FIG. 9. Rather, the example integrated numeracy learning environment 900 can include fewer or additional components not illustrated in FIG. 9 (e.g., additional instruments, tasks, feeds, etc.).

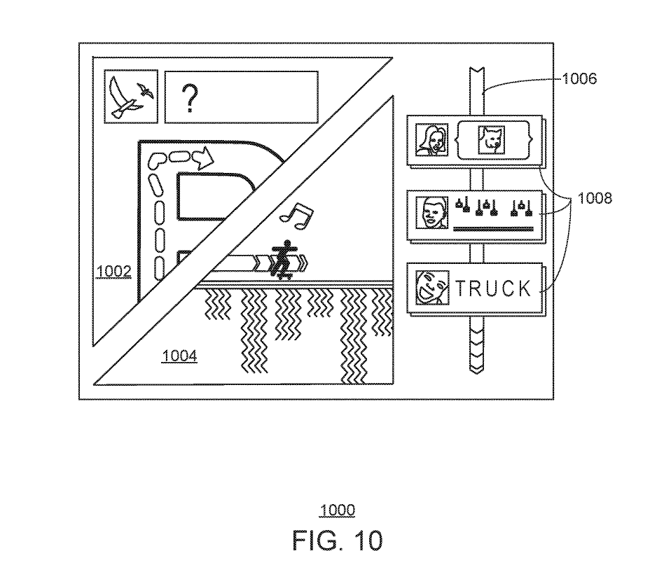

FIG. 10 is an example single social feed interface that integrates numeracy and literacy apps. The example screenshot of the single social feed interface is generally referred to using the reference number 1000.

As shown in FIG. 10, the social feed interface 1000 may present users with a literacy option 1002, a numeracy option 1004, and a curated, scrolling social feed 1006 of peer-completed tasks 1008 within their zone of proximal development. The social feed 1006 on the right may be dragged up and down to access history and additional shared tasks. In some examples, prompted tasks that are responsive to the users' demonstrated interest and competency may be presented to the users. For example, the tasks 1002, 1004 may be literacy and numeracy tasks that are within the zone of proximal development of the user.

The diagram of FIG. 10 is not intended to indicate that the social feed interface 1000 is to include all of the components shown in FIG. 10. Rather, the example social feed interface 1000 can include fewer or additional components not illustrated in FIG. 10 (e.g., additional tasks, feeds, etc.).

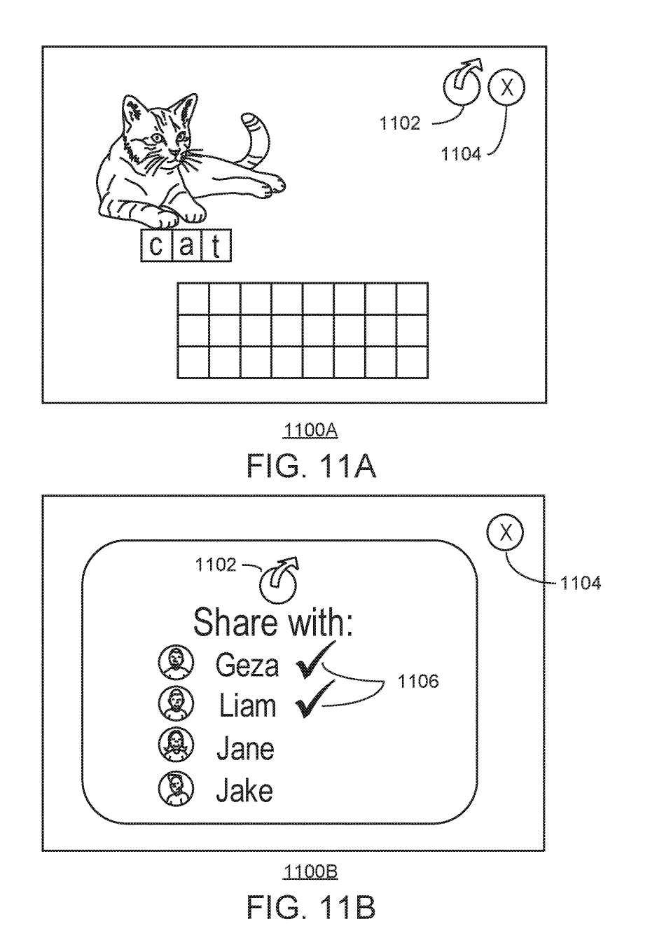

FIGS. 11A and 11B illustrate example sharing mechanism for sharing current tasks with other users. The example diagrams of the sharing mechanism are generally referred to using the reference numbers 1100A and 1100B.

In some examples, a user may want to share a current task. For example, a user may be performing a favorite task, and want to share it with friends. The user may want to share the task because the friend may enjoy doing it, or because the friend might be able to help the user with the task after the friend completes the task. In another example, a user may be dissatisfied with the current set of items on the social feed, and may want to do something that the user sees someone else doing. Thus, the user may want to see what other users are working on. In another example, a user may be proud of having completed a task successfully, and want to show the completed task in the social feed as a form of social validation or reward. Thus, the system may allow the user to share a current task with a class, or to particular peers in the class. For example, such sharing may be similar to reposting an enjoyable post or sharing a post on a social media site.

For example, a task that a user may be currently working on may be particularly enjoyable. The user may want to let friends try the activity too. As shown in 1100A, in some examples, there may be a share button 1102 on the top-right portion of the screen to allow the user to share the current task with other users. For example, the share button 1102 may be next to the exit task button 1104.

As shown in 1100B, in some examples, clicking the share button 1102 may then make a list of your classmates appear. For example, the list of classmates may include profile pictures and written names. In some examples, the written names may be voice-synthed if touched. In some examples, a voice may prompt a user to select friends to receive the task. For example, the voice may use a child-friendly language. In some examples, clicking the icon may then make a checkmark 1106 appear. In some examples, the voice may then say the name of the student to receive the shared task.

In some examples, immediate sharing may be used. For example, the system may share a task immediately when the user checks their name under the “share with” button. Thus, a user could recruit a friend for help on the task immediately. For example, if the user is stuck, the user may want their friends to go try the task out. In some examples, the user may recruit a friend to do the task together. For example, the two may complete the task similar to pair programming)

In some examples, sharing may be allowed after finishing a task. For example, the presence of the task in other friends' feed may serve as an achievement board. In other words, a user might enjoy positive effects of competition or gamification from the presence of the completed task in other friends' feeds. This may also incentivize users to keep completing tasks instead of potentially going into a game to spam all their friends with tasks without actually doing tasks themselves.

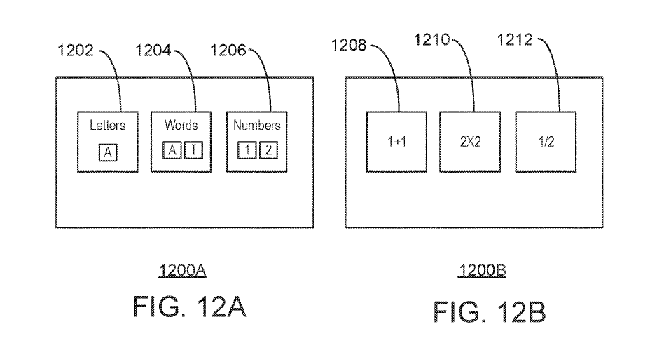

FIGS. 12A and 12 B illustrate example social feature in which a user can search for a task and then post the task for other users. The example screens of the social feature are generally referred to using the reference numbers 1200A and 1200B.

In some examples, a user may be bored with everything on a social feed and may want to find something very specific. For example, the user may want to find a penguin and type it into a search. Once the user finds the penguin, the user may also want to share the penguin with other users. In some examples, a general-purpose search for a task followed by opening of the task and a retweeting functionality may be used. In some examples, because voice search may perform poorly with children and non-native speakers, a hierarchy-based approach may be used instead. For example, to access such a function a user may be presented with a particular special task on the social feed occasionally. The special task may be a random reward for having completed a task. Thus, a user may be able to choose a next task as a reward, even tasks that are not in the user's feed. In some examples, a persistent mechanism may be used instead. For example, the persistent mechanism may include a consistent reward that may be presented every time a task is completed, as opposed to a random or “special task” reward for successful completion. In some examples, the persistent mechanism may be accessed via a gesture on the feed list. For example, a gesture or tile at a special point in the interface that can always bring a user to the activity-choosing interface. Yet another persistent mechanism may be a history of past-completed items. For example, past-completed items may be presented in the form of a list, or a wall of thumbnails.

As shown in screen 1200A, a user may choose between skills 1202, 1204, 1206 at a top level. For example, the skills may be literacy, such as letters 1202 or words 1204, or numeracy skills 1206. As shown in screen 1200B, the next level may allow a user to select an individual task from a set of tasks 1208, 1210, 1212 within a skill. For example, after selecting the numeracy skill 1206 in screen 1200A, a user may select from addition 1208, multiplication 1210, or division 1212 at screen 1200B. In some examples, the entries may be ordered by any logical method. For example, the entries may be ordered alphabetically, by increasing difficulty, among other suitable ways for ordering the entries.

In some examples, clicking a task may open the task. Clicking to open a task may operate as if a user had opened the task from their social feed. The task may also be added to the end of the user's social feed. In some examples, clicking a share button at the top right may open the same interface shown in 1100B of FIG. 11B above. In some examples, finishing the task, or clicking an exit button, may bring the user back to the social feed.

The diagrams of FIGS. 12A and 12 B is not intended to indicate that the example social feature screens 1200A and 1200B are to include all of the components shown in FIGS. 12A and 12 B. Rather, the example social feature screens 1200A and 1200B can include fewer or additional components not illustrated in FIGS. 12A and 12 B (e.g., additional skills, tasks, etc.).

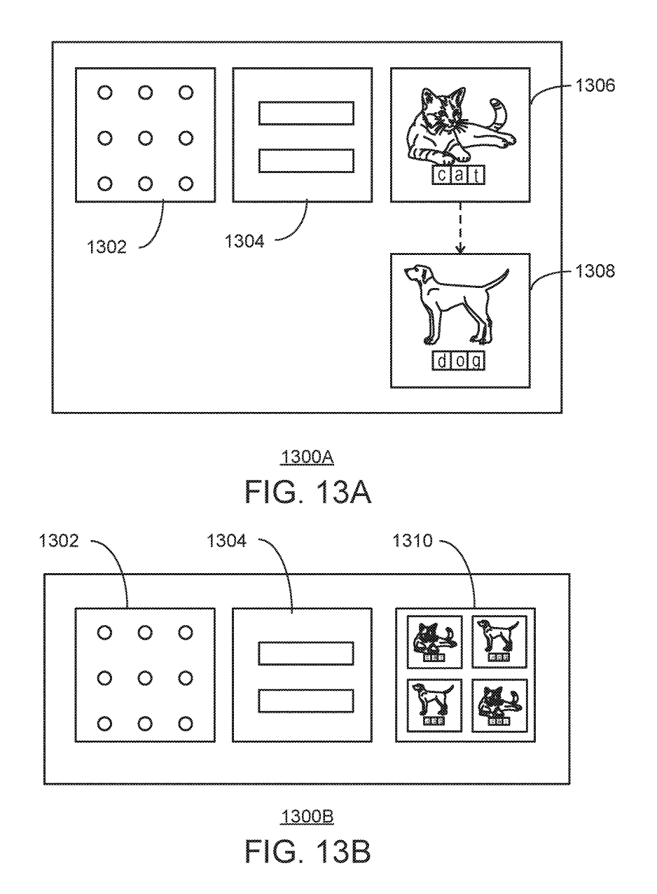

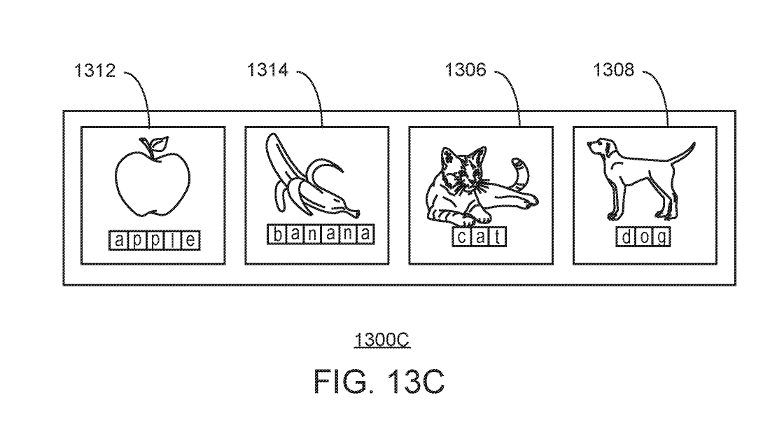

FIGS. 13A-C illustrate additional example social features in which a user searches for a tasks then posts the task for other users. The example screens of the social feature are generally referred to using the reference numbers 1300A and 1300B.

In the social features of FIGS. 13A-C, the social feed may have a “more of this type” of option when a task is finished in the social feed. For example, a user may have finished a typeword task 1306 for “cat.” A typeword task, as used herein, refers to any task in which a user may be requested to type words. In some examples, the social feed may show a rotating list of typeword tasks for different words 1306-1308 as seen in 1300A. For example, the rotating list may switch every second to a different word in that thumbnail slot.

Alternatively, the social feed may be a grid 1310 of four small thumbnails (including the cat thumbnail 1306), in that thumbnail location as seen in 1300B. In some examples, clicking on the rotating thumbnail 1300A or the grid thumbnail 1310 of 1300B may open an activity where a complete list of activities of that sort are shown. For example, all the typeword tasks may be displayed and ordered accordingly to a logical order. For example, all typeword tasks 1312, 1314, 1306, 1308 in 1300C are ordered alphabetically. By clicking on one of these shown tasks, the social feed may then open the task as usual. Upon finishing or exiting the task, the social feed may be displayed again.

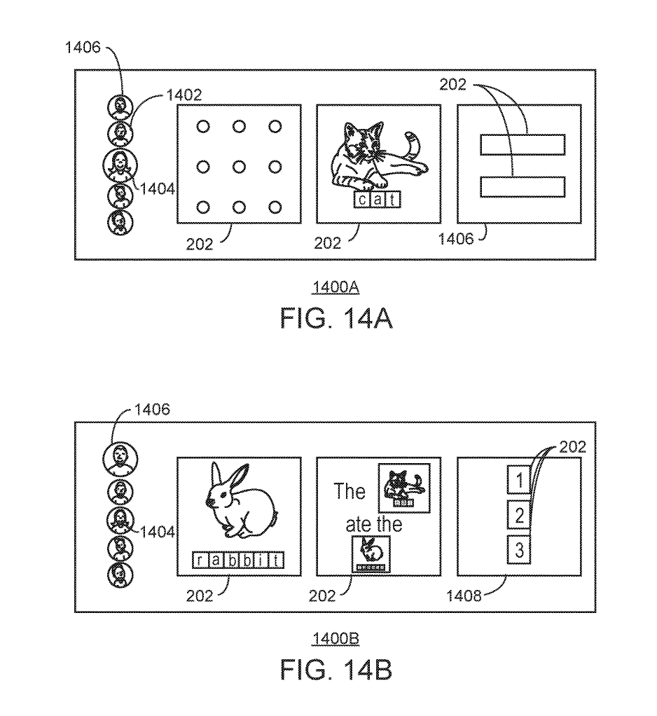

FIGS. 14A and 14B illustrate example social features in which users may browse feeds of friends and perform similar activities. Two example screens depicting the social feature are generally referred to using the reference numbers 1400A and 1400B.

In some cases, a user may see another user performing a task on another tablet that looks interesting. Unfortunately, it may not be on the user's social feed list 1406. However, the user may want to perform the task anyway.

As shown in FIG. 14A, at the edge of the social feed there may be a list of avatars 1402. A larger avatar 1404 may be a selected avatar. In some examples, the selected avatar may be the user's avatar 1404. The avatars of other students 1402 in the class may be shown above and below the user's avatar. If the user clicks on another avatar, then the feed of that other student may be viewed. For example, a user may be looking at his own feed in 1400A. Thus, the user's avatar 1404 in the middle may be larger than the rest of avatars 1402 as it is selected. The user may want to view a friend's feed items. Therefore, the user can click on the topmost avatar 1406 corresponding to the friend and the friend's avatar 1406 may be enlarged as seen in 1400B. The user may then choose to perform any activities 202 listed in the friend's social feed 1408 as seen in 1400B. In some examples, if the user does not see anything of interest on the friend's feed, then the user can just click the user's avatar 1404 to switch back to the user's social feed. Otherwise, if the user is interested in some task 202, the user can click on the task 202 and perform the task 202. This may also add the task 202 to the user's own feed, so that the user may refer back to the newly added task 202 later.

The diagrams of FIGS. 14A and 14B is not intended to indicate that the example social feature screens 1400A and 1400B are to include all of the components shown in FIGS. 14A and 14B. Rather, the example social feature screens 1400A and 1400B can include fewer or additional components not illustrated in FIGS. 14A and 14B (e.g., additional avatars, tasks, lists, etc.).

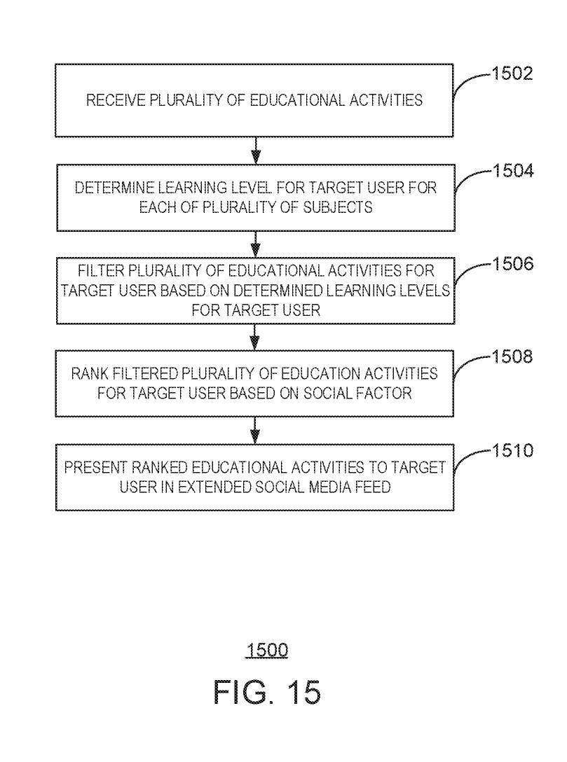

FIG. 15 is a process flow diagram of an example method for presenting educational activities. One or more components of hardware or software of the operating environment 100, may be configured to perform the method 1500. In some examples, various aspects of the method may be performed in a cloud computing system. The method 1500 may begin at block 1502.

At block 1502, a processor receives a plurality of educational activities. For example, the educational activities may include literacy and numeracy activities. In some examples, the educational activities may have each been tagged with a particular level of difficulty.

At block 1504, the processor determines a learning level for a target user for each of a plurality of subjects. For example, the processor may determine the learning level for each target user based on previously completed tasks for each user.

At block 1506, the processor filters the plurality of educational activities for the target user based on the determined learning levels for the target user. In some examples, a learning level for each subject may be determined for a target user based on the activities completed by the user in each subject. For example, the learning level may be a zone of proximal development (ZPD) determined based on previously completed activities.

At block 1508, the processor ranks the filtered plurality of educational activities for the target user based on a social factor. In some examples, the activities may be presented in a non-linear fashion, in a live view, or through any other suitable ranking algorithm to utilize a more constructivist perspective. In some examples, the feed may be designed horizontally with an emphasis on activity completion to show a historical record of completed activities. In some examples, sharing may only occur after completion. In some examples, activities may be organized on the screen in a grid or completely randomly. In some examples, certain activities can be discoverable or searchable instead. In some examples, the feed may be designed to provide a live view of what activities other users were engaged in at that time. In some examples, sharing may thus be allowed regardless of activity completion. Thus, more synchronous immediacy may support children in colocated environments to see what their peers are doing “right now.” In some examples, the system may concentrate on what peers have already done. The system may thus provide more robust, effective ranking for preliterate children in this context with this type of system. In some examples, the activities may be ranked according to weightings that take into account both zone of proximal development and social factors. In some examples, shared activities may be allowed to appear on receiver's feeds even if the activities were outside the receiver's ZPD. In some examples, the shared activities in receiver's feeds may be manipulated or queued according to any of the techniques described above. In some examples, there may be no limits on the number of activities in a feed, but the activities may be ordered according to a user's ZPD.

In some examples, a “popularity” of activities may be emphasized by displaying small thumbnails of peers' faces under the activities they completed. A ranking algorithm may also incorporate popularity as a relevant factor. In some examples, other visual ways to surface popularity of activities to drive peer-motivation may be used when users do not have mental models of social networking. For example, colorful border or different background color may be used to represent the popularity for each activity in the extended social media feed. In another example, thumbnail size may be used to represent popularity, with bigger thumbnails indicating more popular activities. In yet another example, a positioning of the thumbnails may be used to indicate popularity, with more popular activities being elevated vertically to rise above other less popular activities. In some examples, the number of people who completed that task may be presented similar to an “unread mail” badge in phones. In some examples, subtle animations may be used to emphasize particularly popular tasks. In some examples, particularly popular or recommended tasks can be pinned to a standard part of the screen that may be reserved for popular items. In some examples, the ranking algorithm may not prioritize recency. In some examples, the ranking algorithm may also promote breadth of activity types in addition to depth in one subject area.

At block 1510, the processor presents the ranked educational activities to the target user in an extended social media feed. In some examples, the processor may include a list of avatars corresponding to other users, wherein each user has a list of ranked educational activities. For example, a user may click on another user's avatar to display the other user's ranked educational activities. In some examples, the processor may also present an audio button or automatically playing audio corresponding to an instruction for each ranked educational activity. For example, the audio may automatically play upon a user selected an activity or pressing the audio button. In some examples, the processor may present a digital manipulative including a musical instrument to be used to generate musical artefacts that can be shared with other students. For example, the musical artefacts may be musical pieces. In some examples, the processor may present a number of digital manipulatives including musical instruments that can be collected and combined to form an orchestra to compose musical pieces. For example, the musical instruments may be presented on one screen as shown in FIG. 9 above. In some examples, the processor may present an avatar for each ranked educational activity that indicates a source of each ranked educational activity. For example, the source of an educational activity may be a peer, a teacher, or an algorithm of a computer. In some examples, the processor may display one or more avatars of peers that have completed the ranked educational activities. For example, each ranked educational activity may have one or more avatars below of those peers that have completed the educational activity. In some examples, the processor may display a featural keyboard including features that reflect phonological relationships between letters. For example, the featural keyboard may include any of the features described with respect to FIGS. 7A-E above.

This process flow diagram is not intended to indicate that the blocks of the method 1500 are to be executed in any particular order, or that all of the blocks are to be included in every case. Further, any number of additional blocks not shown may be included within the method 1500, depending on the details of the specific implementation.

FIG. 16 is intended to provide a brief, general description of an example operating environment in which the various techniques described herein may be implemented. For example, a method and system for presenting educational activities can be implemented in such an operating environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types. The example operating environment 1600 includes a computer 1602. The computer 1602 includes a processing unit 1604, a system memory 1606, and a system bus 1608.

The system bus 1608 couples system components including, but not limited to, the system memory 1606 to the processing unit 1604. The processing unit 1604 can be any of various available processors. Dual microprocessors and other multiprocessor architectures also can be employed as the processing unit 1604.

The system bus 1608 can be any of several types of bus structure, including the memory bus or memory controller, a peripheral bus or external bus, and a local bus using any variety of available bus architectures known to those of ordinary skill in the art. The system memory 1606 includes computer-readable storage media that includes volatile memory 1610 and nonvolatile memory 1612.

The basic input/output system (BIOS), containing the basic routines to transfer information between elements within the computer 1602, such as during start-up, is stored in nonvolatile memory 1612. By way of illustration, and not limitation, nonvolatile memory 1612 can include read-only memory (ROM), programmable ROM (PROM), electrically programmable ROM (EPROM), electrically erasable programmable ROM (EEPROM), or flash memory.

Volatile memory 1610 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 1602 also includes other computer-readable media, such as removable/non-removable, volatile/non-volatile computer storage media. FIG. 16 shows, for example a disk storage 1614. Disk storage 1614 includes, but is not limited to, devices like a magnetic disk drive, floppy disk drive, tape drive, Jaz drive, Zip drive, LS-210 drive, flash memory card, memory stick, flash drive, and thumb drive.

In addition, disk storage 1614 can include storage media separately or in combination with other storage media including, but not limited to, an optical disk drive such as a compact disk, ROM device (CD-ROM), CD recordable drive (CD-R Drive), CD rewritable drive (CD-RW Drive), a digital versatile disk (DVD) drive. To facilitate connection of the disk storage devices 1614 to the system bus 1608, a removable or non-removable interface is typically used such as interface 1616.

It is to be appreciated that FIG. 16 describes software that acts as an intermediary between users and the basic computer resources described in the suitable operating environment 1600. Such software includes an operating system 1618. The operating system 1618, which can be stored on disk storage 1614, acts to control and allocate resources of the computer 1602.

System applications 1620 take advantage of the management of resources by operating system 1618 through program modules 1622 and program data 1624 stored either in system memory 1606 or on disk storage 1614. In some examples, the program data 1624 may include personal data including user identifiers. For example, the personal data associated with each user identifier may be used to calculate a learning level or ZPD for each user. In some examples, the user identifiers may also be used for user authentication and for providing customized content based on the learning level or ZPD. For example, the user identifier may be a username and password, a digital certificate based on biometrics such as iris recognition, fingerprint, face recognition, or any other suitable form of user identification. It is to be appreciated that the claimed subject matter can be implemented with various operating systems or combinations of operating systems.

A user enters commands or information into the computer 1602 through input devices 1626. Input devices 1626 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 1626 connect to the processing unit 1604 through the system bus 1608 via interface ports 1628. Interface ports 1628 include, for example, a serial port, a parallel port, a game port, and a universal serial bus (USB).

Output devices 1630 use some of the same type of ports as input devices 1626. Thus, for example, a USB port may be used to provide input to the computer 1602, and to output information from computer 1602 to an output device 1630.

Output adapter 1632 is provided to illustrate that there are some output devices 1630 like monitors, speakers, and printers, among other output devices 1630, which are accessible via adapters. The output adapters 1632 include, by way of illustration and not limitation, video and sound cards that provide a means of connection between the output device 1630 and the system bus 1608. It can be noted that other devices and systems of devices can provide both input and output capabilities such as remote computers 1634.

The computer 1602 can be a server hosting various software applications in a networked environment using logical connections to one or more remote computers, such as remote computers 1634. The remote computers 1634 may be client systems configured with web browsers, PC applications, mobile phone applications, and the like.

The remote computers 1634 can be a personal computer, a server, a router, a network PC, a workstation, a microprocessor based appliance, a mobile phone, a peer device or other common network node and the like, and typically includes many or all of the elements described relative to the computer 1602. Remote computers 1634 can be logically connected to the computer 1602 through a network interface 1636 and then connected via a communication connection 1638, which may be wireless.

Network interface 1636 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 1638 refers to the hardware/software employed to connect the network interface 1636 to the bus 1608. While communication connection 1638 is shown for illustrative clarity inside computer 1602, it can also be external to the computer 1602. The hardware/software for connection to the network interface 1636 may include, for exemplary purposes, internal and external technologies such as, mobile phone switches, modems including regular telephone grade modems, cable modems and DSL modems, ISDN adapters, and Ethernet cards.

An example processing unit 1604 for the server may be a computing cluster. The disk storage 1614 may include an enterprise data storage system, for example, holding thousands of impressions.

The user may store the code samples to disk storage 1614. The disk storage 1614 can include a number of modules 1622 configured to implement the presentation of educational activities, including a receiver module 1640, a level detector module 1642, a filter module 1644, a ranker module 1646, and a presenter module 1648. The receiver module 1640, level detector module 1642, filter module 1644, ranker module 1646, and presenter module 1648 refer to structural elements that perform associated functions. In some embodiments, the functionalities of the receiver module 1640, level detector module 1642, filter module 1644, ranker module 1646, and the presenter module 1648 can be implemented with logic, wherein the logic, as referred to herein, can include any suitable hardware (e.g., a processor, among others), software (e.g., an application, among others), firmware, or any combination of hardware, software, and firmware. For example, the receiver module 1640 can be configured to receive a plurality of educational activities.

Further, the disk storage 1614 can include a level detector module 1642 configured to detect a learning level for a target user for each of a plurality of subjects. For example, the subjects may include literacy, and numeracy, among other suitable subjects. In some examples, the level detector module 1642 can be configured to detect a zone of proximal development. In some examples, the filter module 1644 may include code to filter the plurality of educational activities for the target user based on the determined learning levels for the target user. For example, activities outside the zone of proximal development may be filtered out. The disk storage 1614 can include a ranker module 1646 configured to rank the filtered plurality of educational activities for the target user based on a social factor. The disk storage 1614 can also include a presenter module 1648 configured to present the ranked educational activities to the target user in an extended social media feed. For example, the presenter module 1648 configured to modify the extended social media feed transmitted to a user based on the ranking of the plurality of educational activities. In some examples, the social factor includes a number of users that have completed the educational activity. In some examples, the social factor includes a teaching relationship with the target user. In some examples, the learning level includes a zone of development for each educational subject that is tracked and updated as the target user completes educational activities in each subject. In some examples, the presenter module 1648 can receive feedback from the target user via a featural keyboard including features that reflect phonological relationships between letters. In some examples, the ranked educational activities have been modified by at least one of the one or more users. In some examples, the extended social media feed can include access control and activities that are user configurable. For example, the activities may include sign-in into ‘tasks’, ‘challenges’, competitions, etc., that a teacher, a parent or kids themselves can set up. Thus, the operating environment may be customizable for a variety of goal sets.

In some examples, some or all of the processes performed for presenting educational activities can be performed in a cloud service and reloaded on the client computer of the user. For example, some or all of the applications described above for presenting educational activities could be running in a cloud service and receiving input from a user through a client computer.

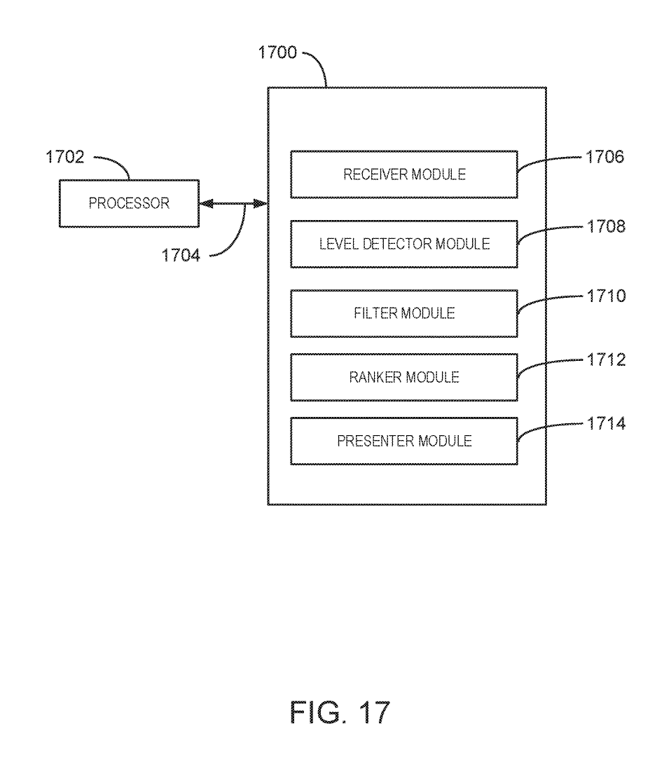

FIG. 17 is a block diagram showing computer-readable storage media 1700 that can store instructions for presenting educational activities. The computer-readable storage media 1700 may be accessed by a processor 1702 over a computer bus 1704. Furthermore, the computer-readable storage media 1700 may include code to direct the processor 1702 to perform steps of the techniques disclosed herein.

The computer-readable storage media 1700 can include code such as a receiver module 1706 configured to receive a plurality of educational activities. A level detector module 1708 can be configured to detect a learning level for a target user for each of a plurality of subjects. For example, the learning level includes a zone of development for each educational subject that is tracked and updated as the target user completes educational activities in each subject. A filter module 1710 can be configured to filter the plurality of educational activities for the target user based on the determined learning levels for the target user.

Further, the computer-readable storage media 1700 can include a ranker module 1712 configured to rank the filtered plurality of educational activities for the target user based on a social factor. For example, the ranker module 1712 configured to rank the filtered plurality of educational activities based on friendships, mentor status, etc. In some examples, the social factor includes a number of users that have completed the educational activity. In some examples, the social factor includes a teaching relationship with the target user.

The computer-readable storage media 1700 can also include a presenter module 1714 configured to present the ranked educational activities to the target user in an extended social media feed. For example, the presenter module 1714 can receive feedback from the target user via a featural keyboard including features that reflect phonological relationships between letters.

It is to be understood that any number of additional software components not shown in FIG. 17 may be included within the computer-readable storage media 1700, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### EXAMPLE 1

This example provides for an example system for presenting educational activities. The example system includes a computer processor and a computer-readable memory storage device storing executable instructions that can be executed by the processor to cause the processor to receive a plurality of educational activities. The executable instructions can be executed by the processor to detect a learning level for a target user. The executable instructions can be executed by the processor to filter the plurality of educational activities for the target user based on the detected learning level for the target user. The executable instructions can be executed by the processor to rank the filtered plurality of educational activities for the target user based on a social factor. The executable instructions can be executed by the processor to present the ranked educational activities to the target user in a extended social media feed. Alternatively, or in addition, the social factor includes a number of users that have completed the educational activity. Alternatively, or in addition, the social factor includes a teaching relationship with the target user. Alternatively, or in addition, the learning level includes a zone of development for each educational subject that is tracked and updated as the target user completes educational activities in each subject. Alternatively, or in addition, the executable instructions can be executed by the processor to receive feedback from the target user via a featural keyboard including features that reflect phonological relationships between letters. Alternatively, or in addition, the ranked educational activities have been modified by at least one other user. Alternatively, or in addition, at least one of the educational activities have been completed by one or more other users. Alternatively, or in addition, the executable instructions can be executed by the processor to modify the extended social media feed transmitted to a user based on the ranking of the plurality of educational activities to present the ranked educational activities to the target user in the extended social media feed.

### EXAMPLE 2

This example provides for an method for presenting educational activities. The example method includes receiving a plurality of educational activities. The method also includes detecting a learning level for a target user for each of a plurality of subjects. The method further also includes filtering the plurality of educational activities for the target user based on the determined learning levels for the target user. The method also includes ranking the filtered plurality of educational activities for the target user based on a social factor. The method further also includes presenting the ranked educational activities to the target user in an extended social media feed. Alternatively, or in addition, the extended social media feed includes access control and activities that are user configurable. Alternatively, or in addition, the social factor includes a teaching relationship with the target user. Alternatively, or in addition, the learning level includes a zone of development for each educational subject that is tracked and updated as the target user completes educational activities in each subject. Alternatively, or in addition, the method can include receiving feedback from the target user via a featural keyboard including features that reflect phonological relationships between letters. Alternatively, or in addition, presenting the ranked educational activities includes including a digital manipulative including a musical instrument to be used to generate musical artefacts that can be shared with other students. Alternatively, or in addition, presenting the ranked educational activities includes including digital manipulatives including musical instruments that can be collected and combined to form an orchestra to compose musical pieces. Alternatively, or in addition, presenting the ranked educational activities includes presenting an avatar for each ranked educational activity that indicates a source of each ranked educational activity. Alternatively, or in addition, presenting the ranked educational activities includes displaying one or more avatars of peers that have completed the ranked educational activities. Alternatively, or in addition, presenting the ranked educational activities includes displaying a featural keyboard including features that reflect phonological relationships between letters.

### EXAMPLE 3

This example provides for an example computer-readable storage device for presenting educational activities. The example computer-readable storage device includes executable instructions that can be executed by a processor to cause the processor to receive a plurality of educational activities. The executable instructions can be executed by the processor to detect a learning level for a target user for each of a plurality of subjects. The executable instructions can be executed by the processor to filter the plurality of educational activities for the target user based on the determined learning levels for the target user. The executable instructions can be executed by the processor to rank the filtered plurality of educational activities for the target user based on a social factor. In addition, the executable instructions can be executed by the processor to present the ranked educational activities to the target user in an extended social media feed. Alternatively, or in addition, the social factor includes a number of users that have completed the educational activity.

### EXAMPLE 4

This example provides for an example system for presenting educational activities. The example system includes means for receiving a plurality of educational activities. The example system includes means for detecting a learning level for a target user. The example system includes means for filtering the plurality of educational activities for the target user based on the detected learning level for the target user. The example system includes means for ranking the filtered plurality of educational activities for the target user based on a social factor. The example system includes means for presenting the ranked educational activities to the target user in a extended social media feed. Alternatively, or in addition, the extended social media feed includes access control and activities that are user configurable. Alternatively, or in addition, the social factor includes a teaching relationship with the target user. Alternatively, or in addition, the learning level includes a zone of development for each educational subject that is tracked and updated as the target user completes educational activities in each subject. Alternatively, or in addition, example system includes means for receiving feedback from the target user via a featural keyboard including features that reflect phonological relationships between letters. Alternatively, or in addition, the ranked educational activities have been modified by at least one other user. Alternatively, or in addition, at least one of the educational activities have been completed by one or more other users. Alternatively, or in addition, example system includes means for modifying the extended social media feed transmitted to a user based on the ranking of the plurality of educational activities to present the ranked educational activities to the target user in the extended social media feed.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for presenting educational activities, comprising:
a computer processor; and
a computer memory, comprising instructions that cause the computer processor to:
receive a plurality of educational activities;
detect a learning level for a target user;
filter the plurality of educational activities for the target user based on the detected learning level for the target user;
rank the filtered plurality of educational activities for the target user based on a social factor; and
present the ranked educational activities to the target user in an extended social media feed.

2. The system of claim 1, wherein the social factor comprises a number of users that have completed the educational activity.

3. The system of claim 1, wherein the social factor comprises a teaching relationship with the target user.

4. The system of claim 1, wherein the learning level comprises a zone of development for each educational subject that is tracked and updated as the target user completes educational activities in each subject.

5. The system of claim 1, the computer memory comprising instructions that cause the computer processor to receive feedback from the target user via a featural keyboard comprising features that reflect phonological relationships between letters.

6. The system of claim 1, wherein the ranked educational activities have been modified by at least one other user.

7. The system of claim 1, wherein the extended social media feed comprises access control and activities that are user configurable.

8. The system of claim 1, wherein the processor is to modify the extended social media feed transmitted to a user based on the ranking of the plurality of educational activities to present the ranked educational activities to the target user in the extended social media feed.

9. A method for presenting educational activities, comprising:
receiving a plurality of educational activities;
detecting a learning level for a target user for each of a plurality of subjects;
filtering the plurality of educational activities for the target user based on the determined learning levels for the target user;
ranking the filtered plurality of educational activities for the target user based on a social factor; and
presenting the ranked educational activities to the target user in an extended social media feed.

10. The method of claim 9, wherein the social factor comprises a number of users that have completed the educational activity.

11. The method of claim 9, wherein the social factor comprises a teaching relationship with the target user.

12. The method of claim 9, wherein the learning level comprises a zone of development for each educational subject that is tracked and updated as the target user completes educational activities in each subject.

13. The method of claim 9, further comprising receiving feedback from the target user via a featural keyboard comprising features that reflect phonological relationships between letters.

14. The method of claim 9, wherein presenting the ranked educational activities comprises including a digital manipulative comprising a musical instrument to be used to generate musical artefacts that can be shared with other students.

15. The method of claim 9, wherein presenting the ranked educational activities comprises including digital manipulatives comprising musical instruments that can be collected and combined to form an orchestra to compose musical pieces.

16. The method of claim 9, wherein presenting the ranked educational activities comprises presenting an avatar for each ranked educational activity that indicates a source of each ranked educational activity.

17. The method of claim 9, wherein presenting the ranked educational activities comprises displaying one or more avatars of peers that have completed the ranked educational activities.

18. The method of claim 9, wherein presenting the ranked educational activities comprises displaying a featural keyboard comprising features that reflect phonological relationships between letters.

19. A computer-readable storage device for presenting educational activities, comprising instructions that cause a computer processor to:
receive a plurality of educational activities;
detect a learning level for a target user for each of a plurality of subjects;
filter the plurality of educational activities for the target user based on the determined learning levels for the target user;
rank the filtered plurality of educational activities for the target user based on a social factor; and
present the ranked educational activities to the target user in an extended social media feed.

20. The computer-readable storage device of claim 19, wherein the social factor comprises a number of users that have completed the educational activity.
